(19) United States
(12) Patent Application Publication
(10) Pub. No.: US 2011/0220035 A1
(43) Pub. Date: Sep. 15, 2011

(54) ACAT animal clipping aide tool plus

(76) Inventor: Timothy A. Kugelman, JR., Whittier, CA (US)

(21) Appl. No.: 12/932,968

(22) Filed: Mar. 10, 2011

Related U.S. Application Data
(60) Provisional application No. 61/339,899, filed on Mar. 10, 2010.

(51) Int. Cl. A01K 15/04; A61D 3/00; F16B 45/00

(52) U.S. Cl. 119/726; 248/339

(57) ABSTRACT

The present invention provides a device to restrain an animal when performing routine procedures such as administering eye drops, brushing the animal's teeth or completing other hygiene or medical procedures. Similar in appearance to a duffle bag or comparable tote, the device is manufactured of heavy duty, soft canvas or comparable synthetic material, produced in a range of sizes for various breeds dogs and cats. The device features raised side walls and a semi rigid base. The front and back panel of the unit comprise soft mesh netting, facilitating easy access to the animal. The interior is lined with soft polyester or wool material and features a series of three, adjustable restraining straps boasting self affixing hook and loop fasteners for use in safely and securely restraining the animal placed within. Notably, the base of the unit features a series of reinforced, round shaped openings, through which the animal's legs are fed. These openings are lined with soft felt or comparable material, further facilitating comfort for the animal.

### CLAIM OF PRIORITY

This patent application claims priority under 35 USC 119 (e) (1) from U.S. Provisional Patent Application Ser. No. 61/339,899 filed Mar. 10, 2010, of common inventorship herewith entitled, “ACAT animal clipping aide tool plus.”

### FIELD OF THE INVENTION

The present invention pertains to the field of small animal restraint systems, and more specifically to small animal restraint systems suitable for use in grooming, such as nail clipping.

### BACKGROUND OF THE INVENTION

The prior art has put forth several designs useful restraining animals for grooming. Among these are:

U.S. Pat. No. 4,644,902 to Reba L. Doyle describes a pet carrier comprising flexible sheet material having a body portion with holes for receiving the pet's legs.

U.S. Pat. No. 5,894,817 to Kathy Manuel describes a multi-function pet carrier comprising a garment having leg openings.

U.S. Pat. No. 6,802,282 to Lyric Muckleroy describes a multi-functional pet carrier comprising flexible panels having leg openings and pockets for carrying articles.

None of these prior art references describe the present invention.

### SUMMARY OF THE INVENTION

It is an object of the present invention to provide an improved device for restraining a small animal for grooming, such as nail clipping.

### BRIEF DESCRIPTION OF THE DRAWINGS

FIG. 1 is a front perspective view of the animal restraint device of the present invention.

FIG. 2 is a top perspective view of the animal restraint device of the present invention showing the interior of the device.

FIG. 3 is an end perspective view of the animal restraint device of the present invention.

FIG. 4 is a bottom perspective view of the animal restraint device of the present invention showing the underside of the device.

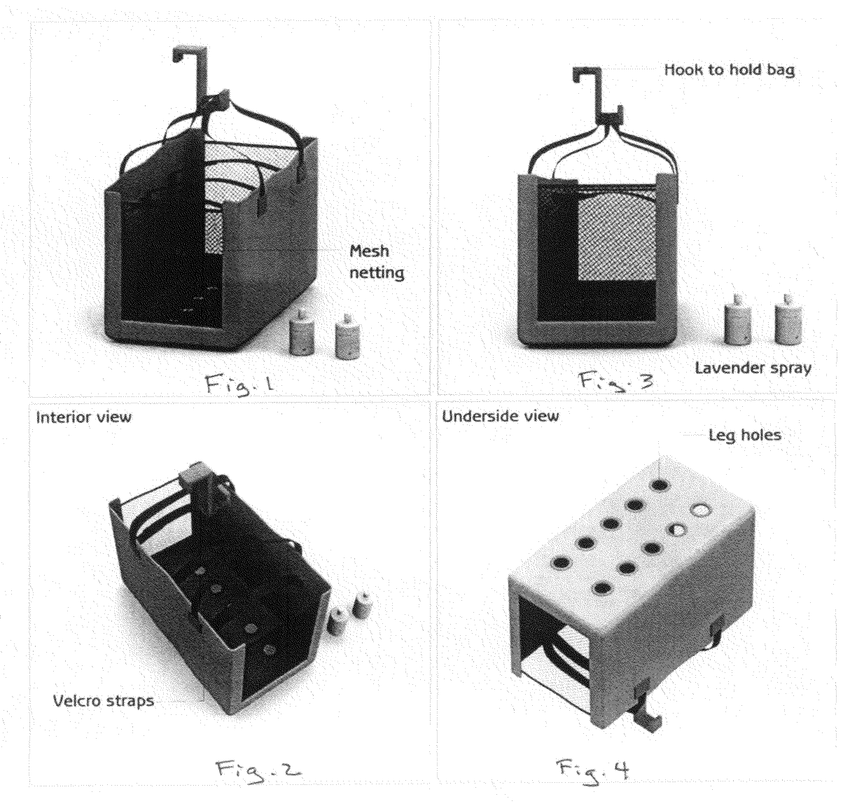

### DETAILED DESCRIPTION OF THE INVENTION

Many people are dog and cat lovers and keep these animals as pets. Caring for the animal's health is of utmost importance for loving pet owners. Grooming a pet includes regular bathing, brushing the pet and trimming the nails. Many pet owners have questions about clipping their pet's nails and fear doing this task. Consequently, the pet's nails become far too long. This is a very common problem which requires attention. It is something that almost any owner can do if an animal cooperates, however most dogs and cats do not like to have their nails clipped and thus struggle violently with their owner while their nails are clipped. Unfortunately, if proper care is not taken, the owner can clip too far into the nail, cutting into the small vein or “quick” of the nail. Cutting into the quick can be extremely painful for the animal, causing pain and bleeding.

Further, struggling with an agitated animal is not only unhealthy for the animal, but can be dangerous for the pet owner as well. Simply stated, trying to clip an animal's nails, only to end up being scratched or bitten by a disgruntled pet can be an extremely frustrating, stressful and painful experience.

The present invention, hereinafter referred to as The ACAT Animal Clipping Aide Tool Plus is a unique invention which offers caring pet owners a practical solution to the aforementioned challenges. Simply stated, The ACAT Animal Clipping Aide Tool Plus is a specially designed portable restraint device configured expressly to enable the pet owner to safely and easily trim an animal's nails.

The device of the present invention can also be used to restrain an animal when performing routine procedures such as administering eye drops, brushing the animal's teeth or completing other hygiene or medical procedures. Similar in appearance to a duffle bag or comparable tote, The ACAT Animal Clipping Aide Tool Plus is manufactured of heavy duty, soft canvas or comparable synthetic material. Produced in a range of sizes for various breeds dogs and cats, The ACAT Animal Clipping Aide Tool Plus measures approximately between 8 and 24 inches in length, 8 inches in depth and 8 inches in width. The ACAT Animal Clipping Aide Tool Plus features raised side walls and a semi rigid base. The front and back panel of the unit boast soft mesh netting, facilitating easy access to the animal. The interior of The ACAT Animal Clipping Aide Tool Plus is lined with soft polyester or wool material and features a series of three, adjustable restraining straps boasting self affixing hook and loop fasteners for use in safely and securely restraining the animal placed within. Notably, the rigid base of the unit features a series of reinforced, round shaped openings, through which the animal's legs are fed. These openings are lined with soft felt or comparable material, further facilitating comfort for the animal. Two durable carrying straps are positioned on each side of the unit for use in easily transporting the device when not in use. As an added feature, included for sale with The ACAT Animal Clipping Aide Tool Plus is a door hook and two 8 ounce bottles of a lavender scented deodorizer formulated to calm the animal when restrained via the device. The ACAT Animal Clipping Aide Tool Plus can be produced in a myriad of attractive colors and printed designs.

Use of The ACAT Animal Clipping Aide Tool Plus is very simple and straight forward. Prior to restraining the animal, the user sprays the interior of The ACAT Animal Clipping Aide Tool Plus with the lavender scented spray, creating a pleasant environment within the restraint. Next, the user gently assists their pet into the device, feeding the animal's individual legs through the appropriate leg openings, thus preventing the animal from moving freely about. The user then secures the strap fasteners about the animal's torso, further restraining the dog or cat. With the animal safely restrained via The ACAT Animal Clipping Aide Tool Plus, the caring pet owner then gently clips their animal's nails or performs other medical procedures. Once the procedure is complete, the user simply removes the straps and frees their pet from the device, storing the unit away until again needed.

The ACAT Animal Clipping Aide Tool Plus is an innovative invention, which offers consumers a number of significant benefits and advantages. Foremost, the ACAT Animal Clipping Aide Tool Plus provides consumers a simple means of safely trimming their dog or cat's nails. A cleverly designed portable restraint boasting individual supports for each leg, as well as adjustable strap fasteners, The ACAT Animal Clipping Aide Tool Plus effectively prevents the animal from moving about as their nails are cut. As such, use of this product enables pet owners to cut their pet's nails in a manner that is comfortable and safe for both the pet and themselves. Allowing the pet owner the time to carefully and neatly trim the animal's nails, use of this product effectively prevents the pet owner from cutting the quick.

Relaxed via the scented lavender, the dog or cat feels comfortable and secure as their nails are trimmed, eliminating the stress associated with this procedure. Sparing the animal pain and injury, use of The ACAT Animal Clipping Aide Tool Plus also prevents the excessive bleeding so often associated with cutting into the quick. Further, because the animal is restrained within The ACAT Animal Clipping Aide Tool Plus, pet owners are spared the painful bite marks or scratches associated with caring for an unrestrained animal.

Not limited to use when trimming an animal's nails, The ACAT Animal Clipping Aide Tool Plus can be utilized with performing other hygiene rituals such as cleaning the animal's ears, brushing their teeth or performing medical exams or minor procedures. Ideal for use by pet owners who may be too timid to trim their animal's nails, The ACAT Animal Clipping Aide Tool Plus also allows veterinarians and groomers to care for the animal's most basic needs with confidence and ease. Durably constructed, The ACAT Animal Clipping Aide Tool Plus will withstand repeated use, with ease.

The ACAT Animal Clipping Aide Tool Plus is a practical invention which enables consumers to trim their animal's nails in a safe and painless manner. Simple to use, this portable restraint provides consumers a practical assist when grooming a much loved pet. Affordably priced, the ACAT Animal Clipping Aide Tool Plus will be well received by professional groomers and dog owners alike, a very sizable market potential.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. An improved device for restraining a small animal, comprising: a specially designed portable restraint device configured expressly to enable a person to perform routine animal maintenance tasks including but not limited to nail trimming, administering eye drops, brushing the animal's teeth, wound treatment, or completing other hygiene or medical procedures, comprising a duffle bag or comparable tote, raised side walls and a semi rigid base, wherein the front and back comprise soft mesh netting, and further comprising three, adjustable restraining straps having self affixing hook and loop fasteners, and wherein the base comprises a series of reinforced, round shaped openings for receiving the legs of an animal.

2. The device of claim 1 further comprising two durable carrying straps positioned on each side of the device.

3. The device of claim 1 further comprising a door hook for hanging the device on a door.

4. The device of claim 1 further comprising a bottle of lavender scented deodorizer formulated to calm an animal when enclosed in the device.

5. The device of claim 1 comprising heavy duty, soft canvas or comparable synthetic material.

6. The device of claim 1 wherein the interior of the device is lined with soft polyester or wool material.

7. The device of claim 1 wherein the round shaped openings for receiving the legs of an animal are lined with soft material including felt, soft polyester or wool material.
